(19) United States
(12) Patent Application Publication
(10) Pub. No.: US 2009/0314945 A1
(43) Pub. Date: Dec. 24, 2009

(54) LIGHTING DEVICE HAVING DETECTION FUNCTION

(76) Inventor: KAI-PO CHEN, Taipei City (TW)

Correspondence Address: LEONG C LEI, PMB # 1008, 1867 YGNACIO VALLEY ROAD, WALNUT CREEK, CA, 94598, US

(21) Appl. No.: 12/144,668

(22) Filed: Jun. 24, 2008

(51) Int. Cl. G01J 5/02

(52) U.S. Cl. 250/353

(57) ABSTRACT

The present invention is a lighting device having detection function, of which the structure features combination of illuminating elements and an infrared detector and a detector shade cover is used as an upper cover for the whole structure of the lighting device to thereby enhance the detection angular range of the infrared detector, simplify the manufacturing process, and providing a uniform and soft lighting source or a bright lighting source. The infrared detector has a function of detecting thermal radiation so that by detecting the thermal radiation from a human body, a signal for supplying power to the illuminating element is provided. When the infrared detector no long detects the thermal radiation from the human body, the control board stops the electric power supplied to the illuminating elements. As such, effective saving of energy can be realized.

### BACKGROUND OF THE INVENTION

(a) Technical Field of the Invention

The present invention relates to a lighting device having detection function, wherein a detector shade cover is used as an upper cover to allow the lighting source to be bright or uniform lighting by mean of the light transmittance of the detector shade cover and to use an infrared detector to detect a thermal source to serve as a signal for activating power supply to the illuminating elements, thereby realizing saving of power.

(b) Description of the Prior Art

With the development of the detector elements, the detector elements are gradually applicable to daily living. Taking an infrared detector as an example, the infrared detector is commonly used to conduct on or cut off the supply of power in order to control lighting elements or lighting devices for the purposes of saving power.

An infrared detector is used to work with a lighting device, such as conventional tungsten filament lighting bulbs, whereby based on the feature of the infrared detector that detects thermal radiation, when a heat source gets into a detection range of the infrared detector, the bulb is automatically lighted. On the other hand, when no heat source is detected, a signal of the detector controls an internal circuit to cut off power supplied to the conventional lighting bulb to reduce energy consumption. However, the conventional lighting bulb, when operating, generates high temperature, which adversely affects the functionality of the infrared detector. Thus, the lighting bulb and the infrared detector must be spaced by a sufficient distance. This makes the overall structure bulky. Further, the high temperature generated by the bulb also causes hardening and frosting of the cover and shade that is made of polymers, leading to shortening of the lifespan of the device. Further, the conventional lighting bulb or the vertical type light-emitting diode has a bulky size, so that for a given space, only a very small quantity of illuminating or lighting elements can be accommodated, and thus, only the basic lighting function can be achieved. Improvements are urgently needed for modern consumers for they are not satisfied with the poor brightness and efficiency of the existing lighting fixtures.

### SUMMARY OF THE INVENTION

In view of the above problems, based on years' experience and research in this field, the present inventor, after having issued U.S. Pat. No. 7,327,254 and Chinese Patent No. 200520000991.X, creates a lighting device having detection function to suit the needs of the modern society.

To meet the desired outdoor lighting, the conventional lighting bulb inevitably generates high temperature during its operation and such a high temperature adversely influences the operation of an infrared detector. Thus, proper installation requires the infrared detector be spaced from the lighting bulb by a proper distance. This makes the overall size very bulky and the installation very difficult. The lighting device having detection function in accordance with the present invention, on the contrary, combine the infrared detector with light-emitting diode that has a small size and excellent light orientation capability and does not generate high temperature during the operation thereof. Thus, in a given space or area, they can be densely arranged without adversely influencing sensitivity of the infrared detector. Further, a lower end of the device in accordance with the present invention can be made corresponding in configuration to a power output terminal for electrical bulb to ease the connection and installation.

Another object of the lighting device having detection function in accordance with the present invention is to simply the manufacturing process and to enhance the use thereof. Thus, a detector shade that is a must to an infrared detector is used to serve as an upper cover of the device so that the upper cover can directly realize expansion of angular range of detection and stable signal. Further, by changing the light transmittance of the upper cover, light from the illuminating elements can be emitted through the upper cover to ensure uniform lighting that is close a natural light source or can be sufficient o serve as a bright light source for outdoor lighting. Thus, the lighting device having detection function of the present invention can be of enhanced functionality and widened range of applications.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view illustrating a lighting device constructed in accordance with the present invention;

FIG. 2 is an exploded view of the lighting device constructed in accordance with the present invention;

FIG. 3 is a cross-sectional view of the lighting device in accordance with the present invention;

FIG. 4 is a perspective view of a lighting device in accordance with a different embodiment of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

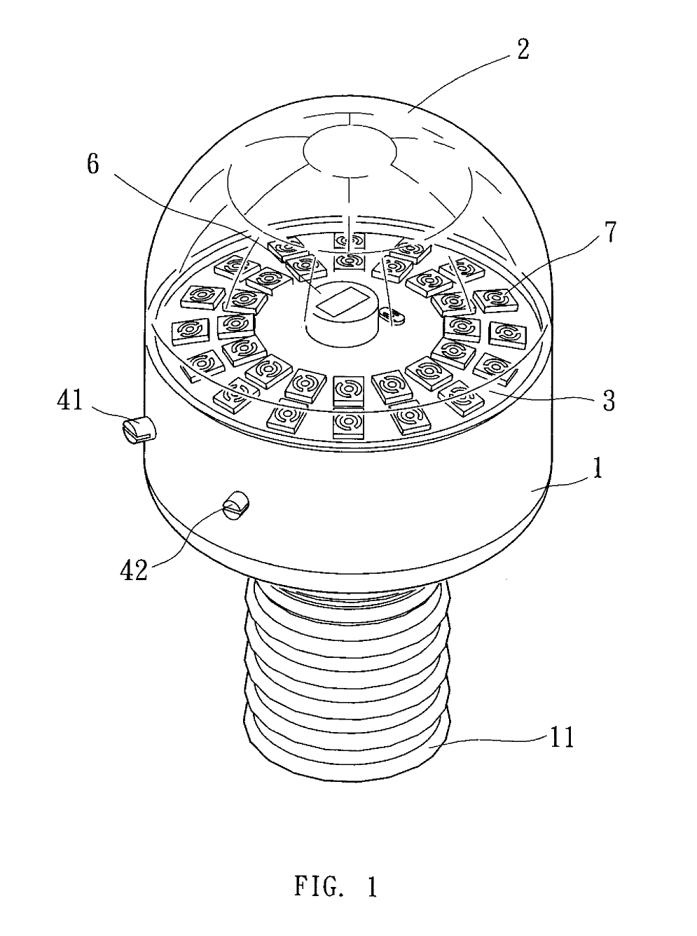

The present invention will be now be described in more detail, especially in respect of the structure and the function thereof, by illustrating a preferred embodiment, reference being had to the attached drawings and in particular to FIGS. 1-3. The present invention provides a lighting device having a detection function, which comprises, in the structure thereof, a lower casing 1, an upper cover 2, a circuit board 3, a control board 4, an infrared detector 6, and illuminating elements 7.

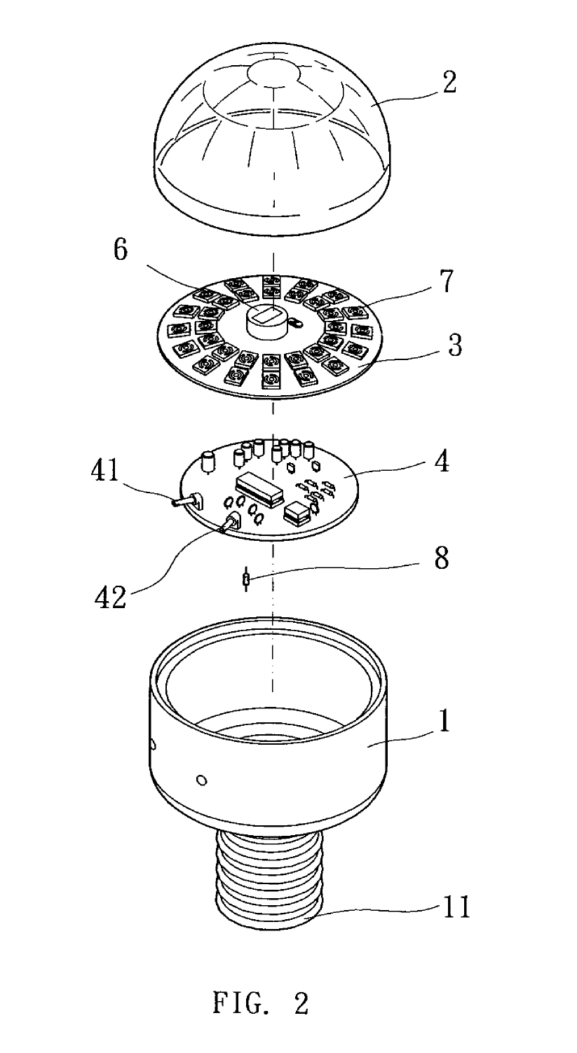

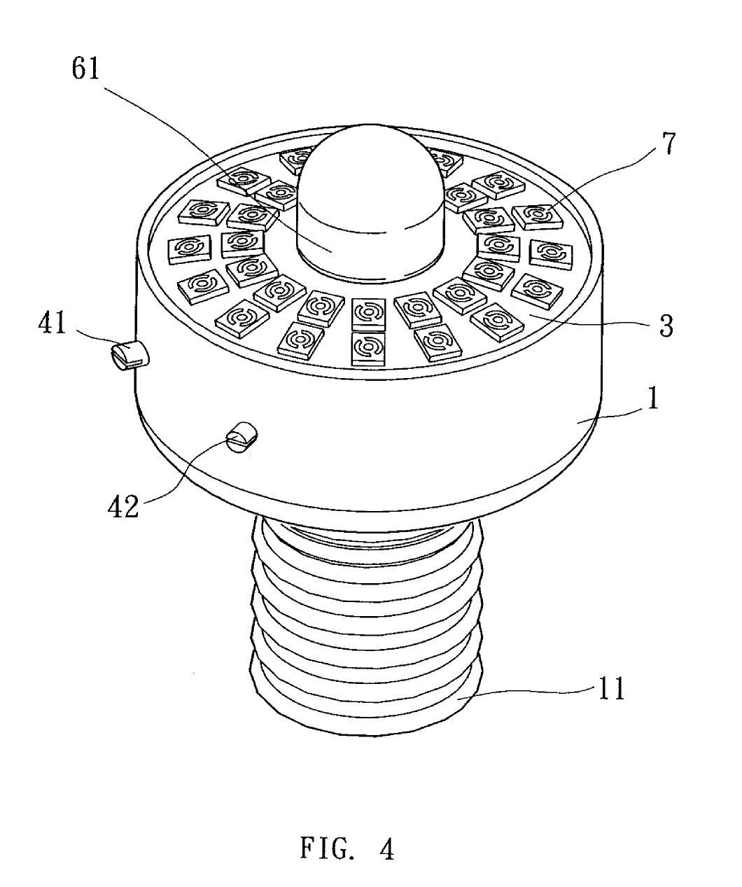

As shown in FIG. 2, in a preferred embodiment of the present invention, the lighting device of the present invention includes a plurality of illuminating elements 7, which are preferably light-emitting diodes made with multiple-chip packaging technology, rendering small volume and high illumination efficiency. The illuminating elements 7 and the infrared detector 6 are mounted on the circuit board 3. The upper cover 2, which can be translucent or light-transmitting, is made to provide the function as an infrared detector shade cover and is arranged above the illuminating elements 7 and the infrared detector 6 at such a distance and location that correspond to the infrared detector 6 and has a lower end mountable to the lower casing 1 to provide expanded angular range of detection and stable receiving of signals. Alternatively, as shown in FIG. 4, to work in different applications, the upper cover 2 can be omitted and a regular detector shade cover 61 can be arranged to cover above the infrared detector 6. The illuminating elements 7 and the infrared detector 6 that are mounted on the circuit board 3 is electrically connected to the control board 4 that is located inside the lower casing by means of conductive wires. The control board 4 also comprises a timing regulation device 41 and a brightness adjustment device 42. The control board 4 serves to receive a transmitted signal from the infrared detector 6 to control power supply to the illuminating elements 7 by means of relay(s). Or, the control board 4 uses the timing regulation device 41 mounted thereon to control the time period of operation of the illuminating elements 7. A resistor 8 is arranged inside a power input terminal 11, which is formed in a lower end of the lower casing 1, to use the brightness adjustment device 42 to adjust the brightness of the illuminating elements 7.

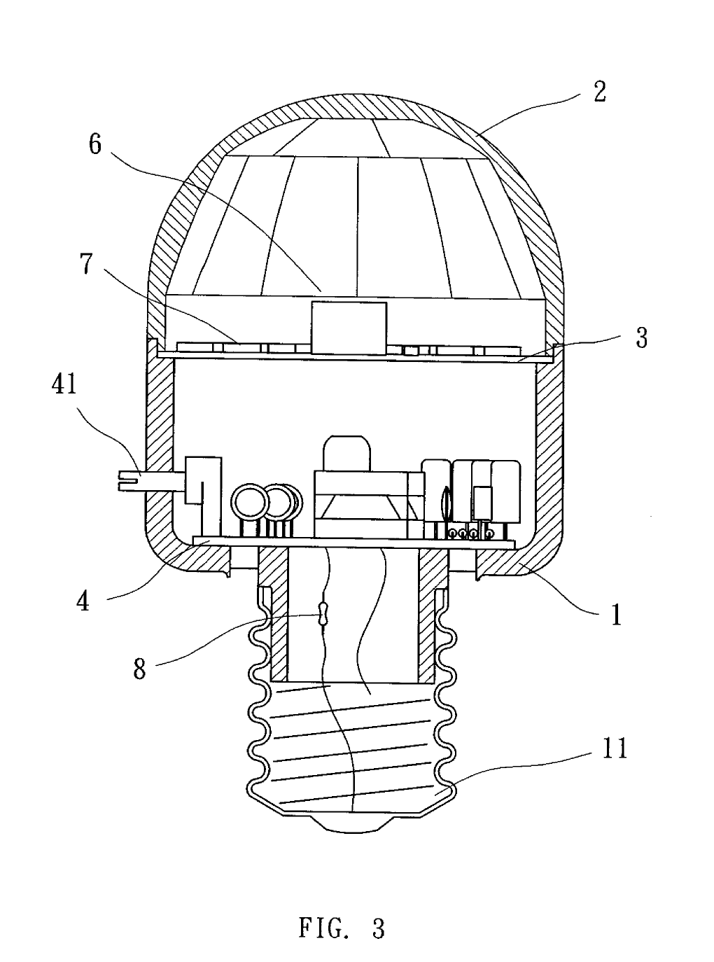

As shown in FIGS. 2 and 3, a tungsten filament lighting bulb always causes high temperature when used, and induces adverse influence on signal receiving of a detector when arranged by the detector. Thus, they have to be installed separate from each other, which leads to inconvenience of installation and bulky size. On the contrary, the lighting device having detection function in accordance with the present invention is based on the development of the state-of-art light-emitting diode technology, and is formed of light-emitting diodes of multiple-chip packaging, so that the volume is small and the lighting efficiency is high, and the lighting device can realize adjustment of operation time period and brightness when incorporating the timing regulation device 41 and the brightness adjustment device 42. A preferred embodiment of the power input terminal 11 can be made to correspond to the screw-type fitting structure of a power output terminal of a conventional lighting bulb for easy replacement and installation. When a person gets into a detection range of the infrared detector 6, the infrared detector 6 detect a signal through the upper cover 2, and transmit the signal to the control board 4 to cause power to be supplied to the illuminating elements 7, and when the person leaves the detection range of the infrared detector 6, power supplied to the illuminating elements 7 is cut off. Further, when the lighting device is used to serve as outdoor lighting, it needs enhanced brightness. However, high brightness of the lighting device would easily make human eyes tired. Thus, to cope with different applications, the present invention also features replacement of upper cover 2 of different light transmittances to ensure uniform and soft lighting and thus enhancing the function of the lighting device of the present invention and widening the applications thereof.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A lighting device comprising:
a circuit board to which an infrared detector and a plurality of illuminating elements are mounted;
a control board to which a timing regulation device and a brightness adjustment device are mounted and connected to the infrared detector and the illuminating elements by conductive wires;
a lower casing containing therein the control board and having a lower end forming a power input terminal;
an upper cover arranged above the infrared detector and the illuminating elements and having a lower end coupled to the lower casing;
wherein the upper cover that is arranged above the infrared detector and the plurality of illuminating elements features an infrared detector shade cover to provide an expanded angular range of detection ad stable receiving of signals.

2. The lighting device as claimed in claim 1, wherein the illuminating elements comprises light-emitting diodes that have small volume and high lighting efficiency.

3. The lighting device as claimed in claim 1, wherein the upper cover is translucent or light-transmitting.

4. The lighting device as claimed in claim 1, wherein the upper cover is selectively omitted and a regular detector shade cover is instead arranged above the infrared detector.
